(19) United States
(12) Patent Application Publication
(10) Pub. No.: US 2023/0158459 A1
(43) Pub. Date: May 25, 2023

(54) HYDROGEN PERMEABLE MEMBRANES, REACTORS AND RELATED METHODS

(71) Applicant: THE UNIVERSITY OF BRITISH COLUMBIA, Vancouver (CA)

(72) Inventors: Curtis BERLINGUETTE, Vancouver (CA); Ryan JANSONIUS, Vancouver (CA); Aiko KURIMOTO, Vancouver (CA)

(21) Appl. No.: 17/920,448

(22) PCT Filed: Apr. 23, 2021
(86) PCT No.: PCT/CA2021/050564

§ 371 Date: Oct. 21, 2022

Related U.S. Application Data
(60) Provisional application No. 63/014,930, filed on Apr. 24, 2020.

(51) Int. Cl. B01D 71/02; C25B 13/05; C25B 15/08; C25B 9/23; C25B 9/65

(52) U.S. Cl. CPC B01D 71/02231; C25B 9/23; C25B 9/65; C25B 13/05; C25B 15/081; B01D 2256/16; B01D 2311/2684; B01D 2325/10

(57) ABSTRACT

A hydrogen permeable membrane comprises a dense layer of a hydrogen permeable metal having first and second faces. The first face of the dense layer has a rough surface which may be formed for example by electrodeposition of a hydrogen permeable metal such as palladium. One or more co-catalysts are provided on the rough surface. The co-catalysts may comprise thin sputtered layers. The one or more co-catalysts have an area density not exceeding 20 µg per cm²; and/or a majority of the co catalysts are in an outer portion of the rough surface, the outer portion of the rough surface being less than one half of a thickness of the rough surface defined by peaks of the rough surface. The membrane may be used in a cell to facilitate chemical reactions including hydrogenation, dehydrogenation and hydrodeoxygenation reactions.

### CROSS-REFERENCE TO RELATED APPLICATIONS

This application claims priority from U.S. Application No. 63/014930 filed 24 Apr. 2020 and entitled PALLADIUM MEMBRANE REACTOR AND USE THEREOF which is hereby incorporated herein by reference for all purposes. For purposes of the United States of America, this application claims the benefit under 35 U.S.C. §119 of U.S. Application No. 63/014930 filed 24 Apr. 2020 and entitled PALLADIUM MEMBRANE REACTOR AND USE THEREOF.

### FIELD

This invention relates to co-catalyst enhanced hydrogen permeable membranes, electrochemical reactors which include such membranes, methods for making such membranes and methods for performing certain chemical reactions. In some embodiments the membranes comprise palladium membranes carrying one or more co-catalysts. The membranes and electrochemical reactors have example application in hydrogenation reactions (including deuteration reactions).

### BACKGROUND

Hydrogenation reactions and dehydrogenation reactions are chemical reactions involving molecular hydrogen. In a hydrogenation reaction molecular hydrogen reacts with a molecule. An example of a hydrogenation reaction is a reaction that reduces or saturates an unsaturated organic molecule (e.g. a molecule that includes one or more carbon-carbon double or triple bonds). For example the reaction of ethene (C₂H₄) to ethane (C₂H₆) is a hydrogenation reaction.

Hydrogenation reactions are deployed at large scale for chemical, food, and biofuel production. Most hydrogenation reactions that are currently being applied in industry use reaction conditions involving high temperatures and pressures. Operating at high temperatures and pressures raises significant safety issues and can require significant energy input. Many hydrogenation reactions use hydrogen gas, often derived from fossil fuels.

Deuteration reactions are a type of hydrogenation reaction in which ordinary hydrogen (atomic weight 1) is replaced by deuterium (an isotope of hydrogen that has atomic weight 2). Deuteration reactions are of value in the pharmaceutical industry, because the C—D bond is stronger than the C—H bond. This tends to reduce the susceptibility of drugs to metabolic cleavage. This link between deuteration and pharmacokinetic properties for bioactive molecules was established^{,} and the U.S. Food and Drug Administration approved the first deuterated drug, deutetetrabenazine (trade name: Austedo), in 2017. Other deuterated versions of common drugs are currently under phase II and III clinical trials.

There is a need for safer and more sustainable ways to perform hydrogenation/deuteration reactions.

### SUMMARY

This invention has a number of aspects, these include: without limitation:
hydrogen-permeable membranes;
methods for making hydrogen-permeable membranes;
electrochemical cells for use in chemical reactions including hydrogenation/deuteration reactions
methods for performing hydrogenation/deuteration reactions;
methods for performing dehydrogenation reactions;
methods for performing hydrodeoxygenation reactions.

Various embodiments of the present invention include a hydrogen permeable membrane that includes a dense metal (e.g. palladium) that is coated on a first face with one or more co-catalysts. The co-catalysts may include, for example, one or more of: platinum (Pt), iridium (Ir), ruthenium (Ru), gold (Au), nickel (Ni), silver (Ag) and copper (Cu). Ni, Ag, and Cu, may be applied for hydrogenation of carbonyl groups, for example.

The co-catalysts are applied in a very thin layer or layers (e.g. a layer that has a thickness of 50 nm or less and in some embodiments is in the range of about 7 to 35 nm). The layer of co-catalysts is not continuous over the first face of the membrane.

In some embodiments the first face of the membrane is rough and the co-catalyst(s) are concentrated in an outermost part of the membrane. Such membranes have been shown to possess excellent hydrogen permeability and high catalytic reactivity.

Electrochemical cells may incorporate hydrogen permeable membranes as described herein. For example, such membranes may be provided in multi-chamber electrochemical cells. In an example embodiment an electrochemical cell comprises:
a chemical reaction chamber;
an electrochemical reaction chamber;
an anode exposed in said electrochemical reaction chamber;
a metallic membrane comprising a co-catalyst, between said chemical reaction chamber and said electrochemical reaction chamber, wherein said co-catalyst is exposed in said chemical reaction chamber, and wherein said metallic membrane is selected to electrochemically reduce a hydrogen ion to a hydrogen atom and to allow said hydrogen atom to diffuse through said membrane.

Some aspects of the invention apply the principle that, in an electrocatalytic palladium membrane reactor, a co-catalyst may enhance permeation of all isotopes of hydrogen and may increase overall catalytic reactivity over a broad substrate scope and a wide span of chemical reactions.

One aspect of the invention provides a hydrogen permeable membrane comprising: a dense layer of a hydrogen permeable metal having first and second faces; the first face of the dense layer having a rough surface; and one or more co-catalysts on the rough surface. the one or more co-catalysts have an area density not exceeding 20 µg per cm²; and/or a majority of the co-catalysts are in an outer portion of the rough surface, the outer portion of the rough surface being less than one half of a thickness of the rough surface defined by peaks of the rough surface; and/or the one or more co-catalysts are in the form of a discontinuous layer having a thickness of 50 nm or less on the rough surface. In some embodiments the dense layer is a layer of palladium or a palladium alloy. In some embodiments the rough surface is provided by a layer of palladium black.

In some embodiments at least 60% of the co-catalyst is concentrated in an outer ⅓ of the rough surface of the first face of the dense layer.

In some embodiments the one or more co-catalysts comprise one or more transition metals. For example the one or more co-catalysts may comprise a co-catalyst selected from the group consisting of: platinum (Pt), iridium (Ir), ruthenium (Ru), gold (Au), nickel (Ni), silver (Ag) and copper (Cu); or a co-catalyst selected from the group consisting of: platinum (Pt), iridium (Ir), ruthenium (Ru), and gold (Au). In some embodiments the one or more co-catalysts comprise or consists of platinum. In some embodiments the one or more co-catalysts comprise or consists of gold.

In some embodiments the one or more co-catalysts have a maximum thickness on the first face not exceeding 50 nm. For example, the one or more co-catalysts have a maximum thickness on the first face in the range of 15 nm to 25 nm or about 20 nm.

In some embodiments the rough surface comprises a layer of palladium black deposited on the dense layer.

In some embodiments an actual surface area of the first face is at least 150 times or 200 times or 200 times larger than a geometric area of the first face.

In some embodiments the dense layer comprises palladium having a purity of at least 95%.

In some embodiments the dense layer comprises a hydrogen storage material.

In some embodiments the dense layer comprises a foil having a thickness of 100 µm or less, for example a thickness in the range of 15 µm to 40 µm.

In some embodiments the dense layer comprises a fluid permeable substrate and a layer of the hydrogen permeable metal on the substrate.

In some embodiments the dense layer comprises a deuterium selective material.

Another aspect of the invention provides electrochemical cells comprising hydrogen permeable membranes as described herein that are located between a chemical reaction chamber and an electrochemical reaction chamber. The cells include an anode (or counter electrode) in fluid contact with the electrochemical reaction chamber.

In some embodiments the chemical reaction chamber comprises a flow field in contact with the first face of the membrane.

In some embodiments the membrane is clamped between the flow field and a clamping plate and the clamping plate is formed with apertures which provide fluid communication between the second face of the membrane and the electrochemical reaction chamber.

In some embodiments an ion-permeable membrane is provided in the electrochemical reaction chamber between the anode and the membrane, the ion permeable membrane dividing the electrochemical reaction chamber into a first part in contact with the membrane and a second part in contact with the anode. The ion-permeable membrane may comprise a proton transport membrane.

In some embodiments the cell comprises a reference electrode in the first part of the electrochemical reaction chamber.

In some embodiments the cell comprises an acid solution in the electrochemical chamber. In some embodiments the acid solution comprises deuterium ions and a ratio of deuterium ions to hydrogen ions in the acid solution is at least 1:1.

In some embodiments the chemical reaction chamber comprises a serpentine flow field. The flow field may, for example comprise a triple serpentine flow pattern.

A power supply may be connected between the anode and the membrane with a polarity such that the membrane is electrically negative relative to the anode.The power supply may be configured to supply an electrical current to the membrane and to regulate the electrical current to have a value in the range of 10 to 400 mA per cm² of the geometric area of the first face of the membrane.

Another aspect of the invention provides the use of a membrane as described herein for providing hydrogen for a chemical reaction. In some embodiments the chemical reaction comprises hydrogenation, dehydrogenation, or hydrodeoxygenation.

Another aspect of the invention provides the use of an electrochemical cell as described herein for providing hydrogen for a chemical reaction. In some embodiments the chemical reaction comprises hydrogenation, dehydrogenation, or hydrodeoxygenation.

Another aspect of the invention provides methods for making hydrogen permeable membranes as described herein. In some embodiments a method comprises providing a layer of a hydrogen permeable metal having a rough surface on a first face thereof; and sputter depositing the one or more co-catalysts onto the rough surface of the hydrogen permeable metal.

In some embodiments providing the layer of the hydrogen permeable metal comprises electrodepositing palladium black on a foil of the hydrogen permeable metal.

In some embodiments the electrodepositing comprises placing the first face of the hydrogen permeable metal in contact with a solution comprising a palladium salt and passing an electrical current through the solution. In some embodiments the palladium salt comprises palladium chloride.

In some embodiments the method comprises electrodepositing in the range of 3 to 5 mg of palladium per cm² of the geometric area of the first face of the hydrogen permeable metal layer.

In some embodiments the method comprises annealing the layer of the hydrogen permeable metal prior to the electrodepositing.

In some embodiments the sputtering is performed in an inert gas atmosphere such as an argon atmosphere.

In some embodiments the hydrogen permeable metal is palladium.

In some embodiments the hydrogen permeable metal is deuterium selective.

In some embodiments t the hydrogen permeable metal comprises a hydrogen storage medium.

In some embodiments the one or more co-catalysts comprise one or more transition metals.

In some embodiments the one or more co-catalysts comprise a co-catalyst selected from the group consisting of: platinum (Pt), iridium (Ir), ruthenium (Ru), gold (Au), nickel (Ni), silver (Ag) and copper (Cu) or a co-catalyst selected from the group consisting of: platinum (Pt), iridium (Ir), ruthenium (Ru), and gold (Au).

In some embodiments the one or more co-catalysts comprises or consists of platinum.

In some embodiments the one or more co-catalysts comprises or consists of gold.

In some embodiments the method comprises controlling the sputtering to limit a deposition thickness of the one or more co-catalysts to 50 nm or less.

In some embodiments the method comprises controlling the sputtering to limit a deposition of the one or more co-catalysts to an area density not exceeding 20 µg per cm² of a geometric area of the rough surface.

In some embodiments the method comprises controlling the sputtering to apply the one or more co-catalysts at a sputter-deposition rate of about 0.2 nm/s.

In some embodiments providing the layer of the hydrogen permeable metal comprises rolling palladium to form the palladium into a foil having a thickness in the range of 25 µm to 150 µm.

Another aspect of the invention provides a methods for performing coupled chemical and electrochemical reactions. In some embodiments a method comprises applying an electrical potential between an anode and a hydrogen permeable membrane as described herein; oxidizing a first reactant at the anode to form at least one oxidized product and hydrogen ions; at the second face of the hydrogen permeable membrane reducing the hydrogen ions to form hydrogen atoms; diffusing the hydrogen atoms through the hydrogen permeable membrane from the second face of the membrane to the first face of the membrane into a chemical reaction chamber; and in the chemical reaction chamber, by the co-catalyst catalyzing a reaction of the hydrogen atoms with a second reactant.

In some embodiments the method comprises transporting the hydrogen ions through an ion exchange membrane to the hydrogen permeable membrane.

In some embodiments the method comprises flowing the second reactant past the first face of the membrane.

In some embodiments the electrical potential causes an electrical current to flow to the membrane wherein the electrical current has a magnitude in the range of 10 mA/cm² of the geometric area of the first face of the membrane to 400 mA/cm² of the geometric area of the first face of the membrane.

In some embodiments the magnitude of the electric current is in the range of 150 mA/cm² of the geometric area of the first face of the membrane to 250 mA/cm² of the geometric area of the first face of the membrane

In some embodiments the second reactant is an alkene comprising a C=C bond and the reaction comprises hydrogenation of the C=C bond. In some such embodiments: the co-catalyst is palladium, iridium, platinum, or gold, or a combination thereof. In some such embodiments the second reactant is dissolved in a solvent (which is a non-polar solvent such as a solvent selected from the group consisting of: hexane, toluene, heptane, benzene, and mixtures thereof in some embodiments.

In some such embodiments the second reactant is an aldehyde or a ketone comprising a C=O bond and the reaction comprises hydrogenation of the C=O bond. In some such embodiments the co-catalyst is platinum, gold, iridium, or palladium, or a combination thereof. In some such embodiments the second reactant is dissolved in a solvent (which is a polar-protic solvent such as a solvent selected from the group consisting of: methanol, ethanol, isopropanol, water, and mixtures thereof in some embodiments).

In some embodiments the method comprises pretreating the co-catalyst with ethylenediamine.

In some such embodiments the second reactant is an imine comprising a C=N double bond and the reaction comprises hydrogenation of the C=N bond. In some such embodiments the co-catalyst is platinum, gold, iridium, or palladium, or a combination thereof. In some such embodiments the second reactant is dissolved in a solvent (which may be a polar-protic solvent such as a solvent selected from the group consisting of: methanol, ethanol, isopropanol, water, and mixtures thereof in some embodments).

In some such embodiments the second reactant is an aldehyde comprising a C=O double bond and the reaction comprises hydrodeoxygenation of the C=O bond. In some such embodiments the co-catalyst comprises platinum, palladium, or nickel, or a combination thereof. In some such embodiments the second reactant is dissolved in a solvent. In some embodiments the solvent is a polar solvent such as an alcohol.

Another aspect of the invention provides methods for performing dehydrogenation reactions. In some embodiments a method comprises: applying an electrical potential between an anode and a membrane as described herein; at the first face of the membrane, oxidizing a first reactant comprising a C—C single bond to form at least one oxidized product and hydrogen atoms; transporting the hydrogen atoms through the membrane into an electrochemical reaction chamber and allowing the hydrogen atoms to form hydrogen gas in the electrochemical reaction chamber. The hydrogen gas may be collected.

In some embodiments the method comprises reacting the hydrogen gas to hydrogenate an organic molecule at a counter electrode.

In some embodiments the electrical potential causes an electrical current to flow to the membrane wherein the electrical current has a magnitude in the range of 10 mA/cm² of the geometric area of the first face of the membrane to 400 mA/cm² of the geometric area of the first face of the membrane.

In some embodiments the magnitude of the electric current is in the range of 150 mA/cm² of the geometric area of the first face of the membrane to 250 mA/cm² of the geometric area of the first face of the membrane

In some embodiments he first reactant is dissolved in a solvent.

In some embodiments the solvent is a non-polar solvent.

In some embodiments the method comprises flowing the first reactant past the first face of the membrane in a flow field.

Further aspects and example embodiments are illustrated in the accompanying drawings and/or described in the following description.

It is emphasized that the invention relates to all combinations of the above features, even if these are recited in different claims.

### BRIEF DESCRIPTION OF THE DRAWINGS

The accompanying drawings illustrate non-limiting example embodiments of the invention.

FIGS. 1A and 1B are schematic sections through hydrogen permeable membranes according to example embodiments.

FIG. 2A is a cross-sectional SEM image of 10 nm thickness gold sputtered on palladium black. FIGS. 2B through 2F are EDX elemental analyses at5 different areas of the SEM image of FIG. 2A.

FIG. 3 is a flow chart illustrating a method for making a hydrogen permeable membrane according to an example embodiment.

FIG. 3A illustrates stages in making a membrane according to the method of FIG. 3. FIGS. 3B, 3C and 3D are respectively scanning electron microscopy (SEM) images of: electrodeposited palladium black; electrodeposited palladium black with a 10 nm thickness of sputtered iridium; and electrodeposited palladium black with a 10 nm thickness of sputtered gold. FIG. 3E shows results of experiments that compared co-catalyst thickness of a sputtered co-catalyst to activity.

FIG. 4 is a schematic illustration of an example electrochemical cell that incorporates a hydrogen permeable membrane as described herein.

FIG. 4A illustrates how a hydrogen permeable membrane with co catalyst may be applied to perform chemical hydrogenation reactions.

FIGS. 4B, 4C and 4D are respectively: a cross sectional schematic view of an example H-cell reactor, a cross sectional schematic view of an example flow field reactor; and an exploded view of an example flow field reactor.

FIG. 5A is plot showing the relative concentration of phenylacetylene (PA), styrene (ST) and ethylbenzene (EB) versus time elapsed from the start of an electrolysis at a current density of 250 mA/cm² using a prototype electrocatalytic palladium membrane reactor (ePMR) flow cell.

FIG. 5B is a bar chart comparing reaction performance in an H-cell and a flow cell (with identical Pd surface area) using four reaction performance metrics: initial reaction rate; maximum styrene concentration; current efficiency (CE); and cell voltage (E_{cell}) at 100 mA/cm².

FIGS. 6A to 6D relate to the hydrogen content in a palladium membrane as a function of current density. FIG. 6A is a plot of the hydrogen content in the palladium membrane (expressed as the H:Pd ratio) for increasingly reducing potentials. FIG. 6B is a plot of the amount of hydrogen in the palladium membrane for each electrolysis current density. FIG. 6C is a plot of the reaction rate as a function of the palladium membrane hydrogen content showing that higher hydrogen content mediates a faster reaction. FIG. 6D is a plot of the maximum styrene concentration as a function of the palladium membrane hydrogen content showing that lower membrane hydrogen content increases selectivity for the alkene intermediate. Error bars for the plots in FIGS. 6C and 6D represent +1 standard deviation of the mean value for at least 3 reactions.

FIGS. 7A, 7B and 7C relate to hydrogen permeation in an ePMR flow cell. FIG. 7A is a schematic illustration showing a setup for measuring the amount of hydrogen that permeated through the palladium membrane using in situ atmospheric-mass spectrometry. FIG. 7B shows that the amount of the hydrogen that permeates through the membrane as current density increases is described by a 2nd order polynomial fit (R² = 0.99). FIG. 7C is a plot of the initial current efficiency of the hydrogenation reaction as a function of the H ion current. Current efficiency decreases linearly with increasing permeated hydrogen (R² = 0.99).

FIGS. 8A to 8C demonstrate electrochemical control of the reaction in an ePMR flow cell. FIG. 8A is a plot of initial reaction rate as a function of current density, FIG. 8B is a plot of maximum styrene concentration as a function of current density, and FIG. 8C is a plot of initial current efficiency as a function of current density. These plots show that control of electrochemical current can provide significant control over the reaction performance. Each data point represents the average of at least three replicates with error bars representing +1 standard deviation of the mean value.

FIG. 9 is a schematic illustration showing operation of a M/Pd-membrane reactor for a hydrogenation reaction in which electrochemically formed activated-hydrogens react with a reactant (in this example a ketone) on a catalyst surface of a hydrogen permeable membrane.

FIG. 9A schematically illustrates hydrogenation of acetophenone. FIG. 9B shows performance of different co-catalysts for hydrogenating acetophenone. FIG. 9C schematically illustrates hydrogenation of styrene. FIG. 9D shows performance of different co-catalysts for hydrogenating styrene. FIG. 9E shows performance of different co-catalysts for hydrogenating hexanal.

FIG. 10 is a bar chart comparing product conversion after 8h in toluene and EtOH for different co-catalysts.

FIG. 11 is a graph showing acetophenone conversion as a function of time for a control experiment in which hydrogen was provided in the form of H2 gas at a pressure of 1 atm.

FIG. 12A is a schematic illustration of a cell architecture used to determine hydrogen flux of Pd and M/Pd and Pd (M = Au, Ir, Pt). FIG. 12B is a bar chart showing the ratio of H₂ gas evolved on the chemical:electrochemical side in toluene (left) and ethanol (right).

FIG. 13 is a plot of a ratio of H₂ gas evolved on the chemical:electrochemical side of a hydrogen permeable membrane as a function of hydrogen adsorption energy. The dotted line is an exponential decay fit of the experimental data.

FIG. 14 is a graph showing temperature programmed desorption (TPD) spectra of H₂ (m/z = 2) for M/Pd and Pd-black deposited Pd-foil membranes. Each sample was loaded with hydrogen in 0.1 M HCl at a reductive potential of -0.4 V (vs. Ag/AgCl) until a total charge of 10 C was passed.

FIG. 15 is a graph showing hydrogen desorption temperature of different M/Pd surfaces (M = Au, Ir, Pt) as a function of hydrogen adsorption energy (ΔG_{H}*).

FIGS. 15A and 15B show reactions for hydrodeoxygenation (HDO) in an ePMR flow cell. FIG. 15A shows that HDO includes a hydrogenation step and a deoxygenation step to remove oxygen atoms from the molecule. FIG. 15B shows HDO of benzaldehyde (a model reactant). FIG. 15C shows HDO for a baseline palladium membrane (without other co-catalyst). FIG. 15D shows that adding Pt as co-catalyst to the palladium membrane increases selectivity for the desired HDO product. FIG. 15E shows that higher temperature results in higher HDO selectivity. FIG. 15F shows results using a Pt co-catalyst on the Pd-membrane at high temperature (70° C.).

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

### Catalytic Hydrogen Permeable Membranes

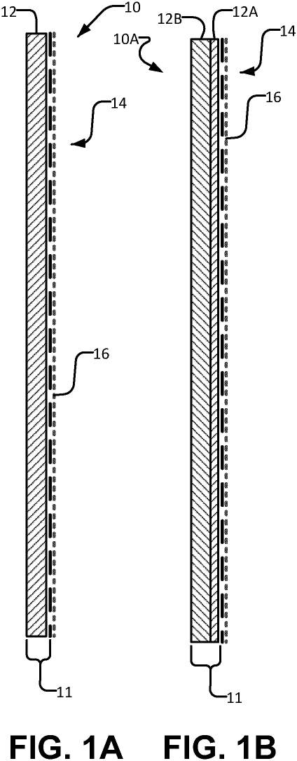

FIG. 1A is a schematic illustration showing a hydrogen permeable membrane 10 according to an example embodiment of the invention. Membrane 10 comprises a substrate 11 which includes a dense layer 12 of a hydrogen permeable metal. For example, dense layer 12 may comprise palladium (which may be pure palladium such as palladium that is 99% or 99.5% or 99.9% or 99.95% pure or a palladium alloy). For example, dense layer 11 may comprise a palladium foil. In one example, substrate 11 comprises a rolled Pd foil.

Dense layer 12 may, for example, have a thickness that is less than 100 µm. In some embodiments the thickness is in the range of 10 µm to 50 µm or 15 µm to 35 µm (e.g. about 25 µm).

In some embodiments first face 14 is rough. For example, first face 14 may have a surface roughness that results in an actual surface area of first face 14 being at least 150 times or at least 200 times or at least 250 times greater than a geometric area of first face 14. The surface roughness may be characterized by scanning electron microscopy (SEM) and/or double-layer capacitance electrochemical surface area (ECSA) measurements. In some embodiments the surface area of first face 14 is about 250 times larger than the geometric area of first face 14.

In some embodiments first face 14 comprises an electrodeposited palladium layer (e.g. a layer of electrodeposited palladium black). Sherbo, Nat. Catal 2018 discusses roughness of electrodeposited palladium layers. Without being bound to any particular theory, the electrodeposited palladium may provide increased surface area that may increase the rate of chemical reactions between hydrogen permeating through dense layer 12 to first face 14 and one or more reactants.

First face 14 of membrane 10 comprises one or more co-catalysts 16. In some embodiments, co-catalyst(s) 16 comprise one or more transition metals. In some embodiments, co-catalysts 16 comprise metals such as one or more of gold (Au), platinum (Pt), iridium (Ir), ruthenium (Ru), palladium (Pd), nickel (Ni), silver (Ag) and copper (Cu). Ni, Ag, and Cu, may be applied for hydrogenation of carbonyl groups, for example. In some embodiments a membrane 10 comprises a plurality of co-catalysts (e.g. a mixture of any two or a mixture of any three or more co-catalysts as described herein)

Co-catalysts 16 may be present in a very thin layer (e.g. a layer that has a thickness of 50 nm or less and in some embodiments is in the range of about 7 to 35 nm or 15 to 25 nm. Where there are plural co-catalysts 16 on a membrane 10 the thickness of layers of individual co-catalysts may be even less. In some embodiments the mass of co-catalyst(s) is less than about 20 ug/cm² on membrane 10 (e.g. about 10 µg/cm²).

The layer of co-catalysts is not continuous over first face 14 of membrane 10.

In some embodiments the thin layers of co-catalyst(s) 16 are deposited by sputtering.

In some embodiments first face 14 of membrane 10 is rough and the co-catalyst(s) are concentrated in an outermost part of membrane 10 (e.g. near tops of peaks of the roughened surface). Membranes having this construction have been demonstrated to possess excellent hydrogen permeability and high catalytic reactivity.

In some embodiments a majority of the co-catalyst is on a top portion of the roughened surface. Portions of the roughened surface near bases of peaks of the roughened surface may carry relatively little of the co-catalyst. In some cases at least 60% of the co catalyst is found in the outer ⅓ of the roughened surface. For example, in a case where the peaks of the roughened surface have heights of about 3 µm at least 60% of the co-catalyst may be located in the top 1 µm of the peaks.

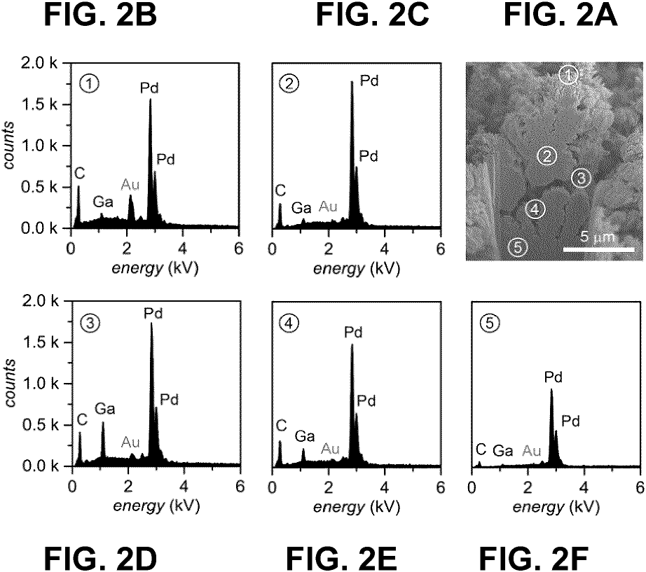

The top-heavy distribution of co-catalyst is demonstrated in FIGS. 2B to 2F which shows that the presence of the co-catalyst gold drops off rapidly with distance from the tops of peaks in the roughened surface.

FIG. 1B shows a hydrogen permeable membrane 10A according to an alternative embodiment. Membrane 10A can be substantially the same as membrane 10 with the exception that dense layer 12 comprises plural layers of different materials. In the illustrated embodiment, dense layer 12 comprises a first part 12A of a first hydrogen permeable material and a second part 12B of a second hydrogen permeable material.

In a non-limiting example embodiment the first hydrogen permeable material is a first metal such as palladium and the second hydrogen permeable material is a second hydrogen permeable metal which may, for example, comprise one or more of: vanadium, niobium, tantalum, scandium, titanium, chromium, yttrium, zirconium, lanthanum or alloys thereof.

In some embodiments the second hydrogen permeable material comprises a deuterium selective material.

In some embodiments the second hydrogen permeable material comprises material that stores hydrogen, for example, a hydrogen storage material such as LiNi₅, SmMgs, Ni black, vanadium, niobium, tantalum, scandium, titanium, chromium, yttrium, zirconium, nickel, aluminium, manganese, lanthanum and suitable alloys including these metals.

A dense layer 12 that incorporates palladium may, for example, be made by any suitable method for depositing palladium on a substrate, membrane foil, or other dense hydrogen permeable material.

In some embodiments the first hydrogen permeable material is deposited on the second hydrogen permeable material, for example, by an electrochemical deposition. The deposition of the first hydrogen permeable material may create a roughened first surface 14.

### Example Methods for Making Catalytic Hydrogen Permeable Membranes

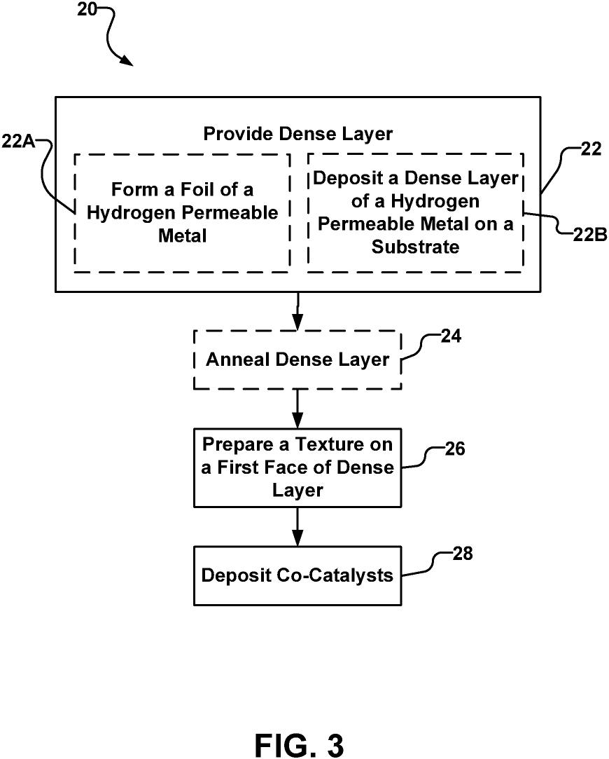

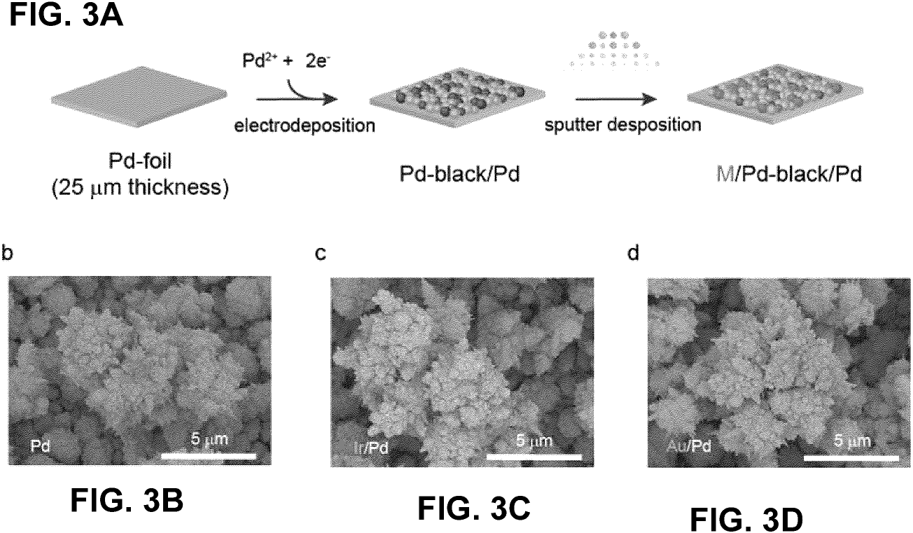

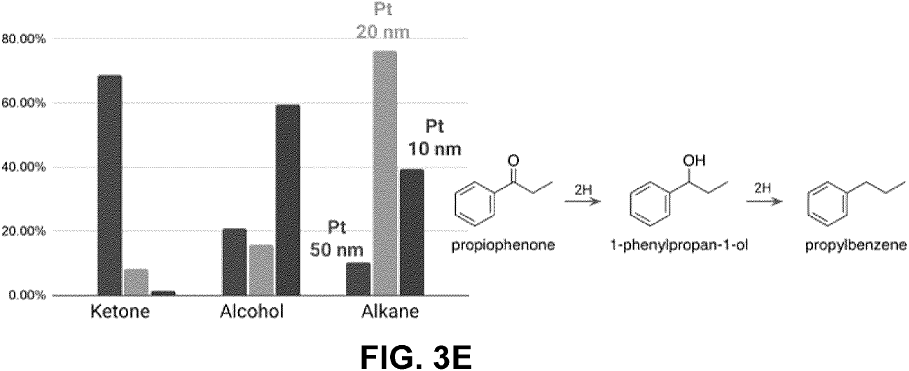

FIG. 3 is a flowchart that illustrates an example method 20 for making a hydrogen permeable membrane of the type described herein. FIG. 3A shows intermediate stages in the method of FIG. 3. Block 22 provides a dense layer 12. Block 22 may, for example comprise one or more of forming a foil of a hydrogen permeable metal as indicated by 22A or depositing a dense layer of a hydrogen permeable metal on a substrate (e.g. by electrodeposition or lamination) as indicated by 22B.

In some embodiments dense layer 12 is annealed in optional block 24.

Block 26 prepares a texture on a first face 14 of dense layer 12. Block 26 may, for example comprise electrodepositing a layer of palladium black on first face 14.

Block 28 deposits a thin layer of one or more co-catalysts on the textured first face 14. In preferred embodiments block 28 comprises applying a thin layer 16 of one or more metallic co-catalysts onto textured first face 14 by sputter deposition. The deposition may be controlled to limit a thickness of the layer of co-catalyst(s) to 50 nm or less. The co-catalysts may include one or more of: Pt, Au, Ru, and Ir, for example. In cases where first face 14 comprises a material other than palladium, palladium may be applied as a co-catalyst.

In a specific example method, Pd foils were rolled from a 1 oz palladium wafer bar to 150 µm thickness. The resulting 150 µm thick palladium foil was then rolled to 25 µm thickness. The 25 µm thick palladium foil was then annealed in Ar at 850° C. for 1.5 hours. Prior to use, the annealed foils were cleaned using 0.5:0.5:1 vol. % conc. HNO₃:H₂O:30% H₂O₂.

A catalyst (surface layer) on the palladium foil was prepared by electrodeposition from a solution of a palladium salt. In specific cases the salt was PdCl₂. For example a 15.9 mM PdCl₂ in 1 M HCl solution (1 M H₂SO₄ solution in some cases) was used for electrodeposition. The foil was placed into a cell as the working electrode, and an Ag/AgCl reference electrode and Pt mesh counter electrode were used. A voltage of -0.2 V vs. Ag/AgCl was applied to the working electrode foil. The electrodeposition was stopped when 9 C of charge (7.38 C/cm²) had been passed, which provides ~5 mg of material (about 4.1 mg/cm²). This additional catalyst layer increases the surface area of the first face of the palladium membrane up to 250-fold. This large increase in surface area helps to facilitate a higher rate of hydrogenation or deuteration. Results obtained with membranes prepared in this manner are discussed elsewhere herein.

Immediately following electrodeposition (see procedures above), the foils were thoroughly rinsed with ultrapure water prepared by a Milli-Q™ system, covered in a 4″ diameter petri dish to maintain cleanliness, and left to dry for ~ 1 hour in ambient conditions.

After drying the palladium foils were secured against the deposition plate of a Leica EM MED020 coating system using Kapton™ tape, the chamber was sealed, and a vacuum applied to achieve a base pressure of 2 ×10⁻⁵ mbar (which required ~20 minutes). Argon was continuously flowed into the chamber to maintain a pressure of 1 ×10⁻² mbar, the plasma was ignited, and voltage was adjusted to maintain a constant sputter current of 70 mA for iridium, and 30 mA for gold and platinum.

Following a 30 s pre-sputter step, the target shutter was opened and 10 nm of co-catalyst (gold, iridium, or platinum) was deposited onto the textured first face provided by the electrodeposited palladium.

The sputter rate for every metal was 0.2 nm/s, as determined by in situ quartz crystal microbalance monitoring. Following sputtering, the shutter was closed, the chamber vented, and the foil removed from the deposition plate.

FIGS. 3B, 3C and 3D show scanning electron microscopy (SEM) images of the catalyst surface before (FIG. 3B) and after (FIGS. 3C and 3D) sputtered deposition of co-catalysts. These images show that the high-surface morphology of the electrodeposited Pd-black layer was retained after sputter deposition of the co-catalysts. ECSA measurements made before and after deposition of the co-catalysts showed a change of less than about 5%.

FIG. 3E shows that the activity of a membrane as described herein for various reactions for different amounts of sputtered co-catalyst. It can be seen that activity is reduced for both smaller and larger thicknesses of Pt co-catalyst. In the results shown in FIG. 3D a 20 nm sputtered thickness of Pt on the high surface-area Pd black rough surface of face 14 resulted in the highest activity, compared to 10 nm and 50 nm thicknesses of the sputtered Pt co-catalyst.

The prepared membranes were used for hydrogenation experiments without any further processing. The same catalysts were used for up to 3 hydrogenation cycles. The co-catalysts on Pd-black were removed and re-deposited after up to 3 uses to make reaction conditions consistent. Each palladium membrane was sufficiently durable to be used for >10 reactions.

### Example Cells Incorporating Catalytic Hydrogen Permeable Membranes

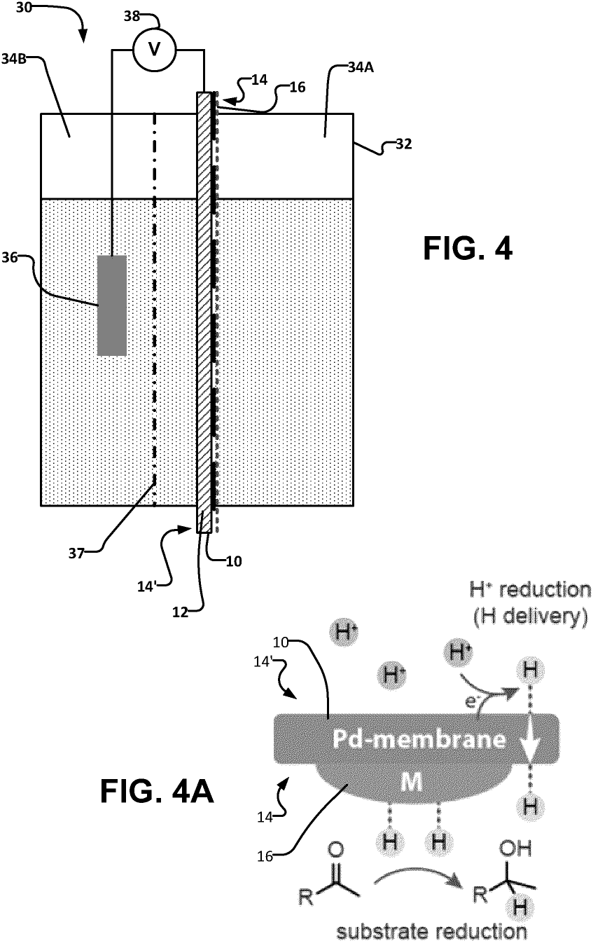

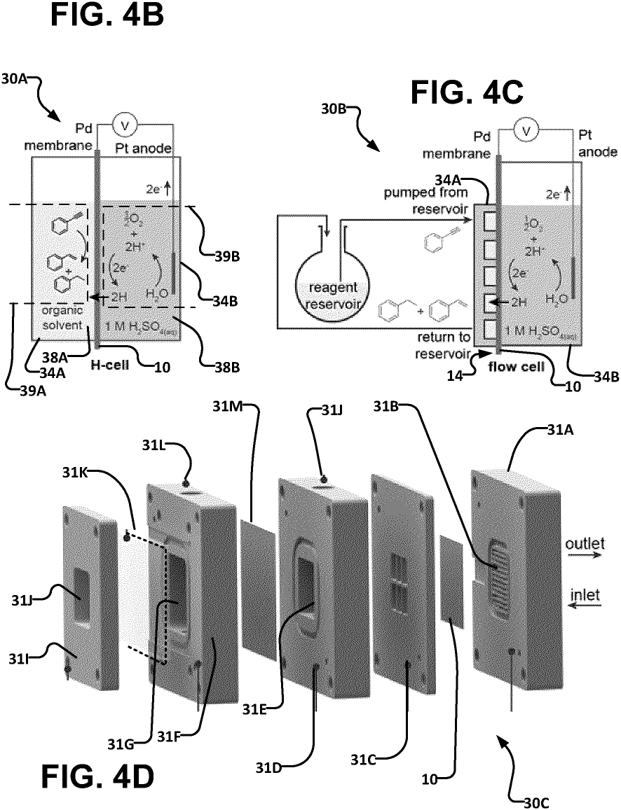

FIG. 4 shows an example cell 30 which incorporates a membrane 10 (or 10A) as described herein. Cell 30 comprises a housing 32 that defines a chemical reaction chamber 34A and an electrochemical reaction chamber 34B. A membrane 10 as described herein is located between chemical reaction chamber 34A and an electrochemical reaction chamber 34B with first face 14 which carries co-catalyst(s) 16 facing into chemical reaction chamber 34A.

An anode 36 is located in the electrochemical reaction chamber 34B. Anode 36 may, for example comprise a suitable metal such as platinum and may have any suitable form such as a mesh, gauze, plate, sintered powder or the like.

An ion permeable membrane 37 (e.g. a cation permeable membrane such as a Nafion™ membrane) is optionally provided between anode 36 and membrane 10. Membrane 37 may advantageously isolate oxidative electrochemistry occurring at anode 36 from proton reduction occurring at membrane 10, which serves as a cathode in cell 30.

A power supply 38 is connected to provide an electrical potential difference between anode 36 and membrane 10 such that membrane 10 is electrically negative relative to anode 36. Power supply 38 may, for example, comprise a potentiostat. A Metrohm Autolab™ PGSTAT302N/PGSTAT204M potentiostat was used for electrochemical experiments.

In operation, as schematically shown in FIG. 4A, hydrogen ions that result from one or more electrochemical reactions at anode 36 travel to second side 14′ of membrane 10 where they are electrochemically reduced to hydrogen atoms that diffuse through dense layer 12 of membrane 10. The hydrogen atoms reach first face 14 of membrane 10 where they participate in chemical reactions (e.g. hydrogenation reactions) with reactants in chemical reaction chamber 34A. A wide range of chemical reactions are possible. Reactants and co-catalysts 16 may be selected to yield desired end products.

Electrochemical cells that include membranes 10 may be used in batch operating modes or in continuous operating modes.

FIG. 4B shows an example two-compartment H-cell reactor 30A which includes a membrane 10 (or 10A). Reactor 30A may be used as a batch reactor (e.g. by putting a liquid reagent 38A containing a reactant into chemical reaction chamber 34A and a solution 38B that can be electrolyzed to form hydrogen ions in electrochemical reaction chamber 34B.

Reactor 30A may be modified for continuous operation by providing suitable piping (indicated schematically by 39A, 39B for flowing reagent 38A and solution 38B through chambers 34A and 34B respectively).

In some embodiments, chemical reaction chamber 34A is a flow-through compartment in which a suitable reagent (e.g. one or more reactants or a solvent containing one or more reactants) is circulated through chemical reaction chamber 34A. For example, FIG. 4C shows an example flow cell 30B in which a reactant (e.g. an organic reagent) is delivered to catalyst surface 14 of membrane 10 (or 10A) by a flow field plate. A flow cell architecture can significantly improve reaction performance. Flow cell architectures like that of reactor 30A can facilitate cost effective and efficient commercial/industrial scale reactions.

In cell 30B, a reagent is delivered (e,g, by one or more suitable pumps) from a reagent reservoir into chemical reaction chamber 34A and back to the reagent reservoir.

FIG. 4D is an exploded view that includes renderings of parts of an example prototype ePMR flow cell 30C having an architecture like cell 30B. Flow cell 30C comprises: an endplate 31A that includes a hydrogen flow field 31B. Membrane 10 is located between a compression plate 31C and endplate 31A. The compression plate may hold membrane 10 firmly against flow field 31B. This design allows a large proportion of the area of membrane 10 to be available for chemical reactions.

Flow field 31B provides a chemical reaction chamber. A reagent may be flowed through flow field 31B by way of an inlet and outlet on an outside of end plate 31A. In this example, flow field 31B has a triple serpentine flow pattern. Other flow patterns are possible. In a prototype embodiment flow field 31B was provided by a 2 cm × 2 cm triple serpentine flow pattern with 1 mm × 1 mm flow channels.

An electrochemical reaction chamber which, in this embodiment is divided into a cathode chamber and an anode chamber is defined primarily by cathode plate 31 D which is formed with an opening 31E that forms a cathode chamber and an anode plate 31F which is formed with an opening 31G that forms the anode chamber. An ion permeable membrane 31M separates the cathode chamber from the anode chamber and is compressed between plates 31D and 31F.

The illustrated cell 30C includes an optional window which allows visual inspection of the anode chamber while cell 30C is in operation. A window sealing plate 31I having a window opening 31J seals a window 31K against anode plate 31F to close the electrochemical reaction compartment.

Suitable seals such as O-rings (e.g. Viton™, square cross section O-rings) are provided to seal the inter-compartmental interfaces.

An anode (e.g. a platinum electrode such as a suitable platinum mesh, foil etc. (not shown in FIG. 4D) is located in the anode compartment. A reference electrode (not shown in FIG. 4D) may be provided in the cathode compartment. The anode may be introduced through port 31L. A reference electrode may be introduced through port 31J. Other ports (not shown) may optionally be provided to circulate electrolyte through the anode chamber and the cathode chamber.

The design of flow cell 30C permits an anode, reference electrode and flow field to be located in separate compartments.

In experiments to assess the performance of membrane 10 as described herein and to assess the overall performance of cell 30C, cell 30C was assembled. A palladium foil membrane 10 as described herein was arranged with first face 14 (which includes the co-catalyst) facing flow field 31B. Compression plate 31C, cathode plate 31D, ion exchange membrane 31M, and anode plate 31F were then positioned over membrane 10. Fasteners situated at the corners of cell 30C were tightened sequentially to compress the seals and create a hermetic seal between the component and component-membrane interfaces.

Viton™ tubing (⅛” ID, ¼” OD) was connected to the inlet and outlet of flow field 31B via PVDF Luer-lok™ couplings. The tubing also connected a 50 mL organic reactant reservoir and peristaltic pump to cell 30C.

Phenylacetylene (0.255 g, 2.5 mmol) and dichloromethane (DCM) (25 mL) were added to the organic reagent reservoir and stirred at a constant rate. To conduct hydrogenation experiments in this device the cathode and anode electrochemical compartments were both filled with 8 mL of 1 M H₂SO₄ electrolyte, then a Ag/AgCl reference electrode and platinum mesh counter electrode were inserted through ports 31L and 31J. For each hydrogenation reaction a fresh solution of phenylacetylene (PA), 25 mL, 0.1 M in DCM, was continuously recirculated from the reagent reservoir through flow field 31B at a rate of 20 mL/min using a peristaltic pump.

Water electrolysis was driven galvanostatically with an electrical current that provided a current density of 10, 50, 100, 250, or 400 mA/cm² of the geometric area of membrane 10 available for the electrolysis.

Reaction progress was monitored by quantifying the amounts of phenylacetylene (PA), styrene (ST) and ethylbenzene (EB) in 20 µL aliquots taken from the reagent reservoir using gas chromatography-mass spectrometry (GC-MS). Reaction aliquots were sampled every 1-30 minutes, depending on the current density and the duration of the reaction (e.g., 400 mA/cm² reactions were sampled approximately every 1 minute for the first 5 samples, then every 10 minutes for the remaining samples, and 10 mA/cm² reactions were sampled approximately every 30 minutes from start to finish), such that 10-15 samples were collected for each reaction. Reactions were monitored by gas chromatography-mass spectrometry (GC-MS) by diluting 20 µL of the reaction mixture in 1 mL of DCM. These data were used to generate concentration versus time plots.

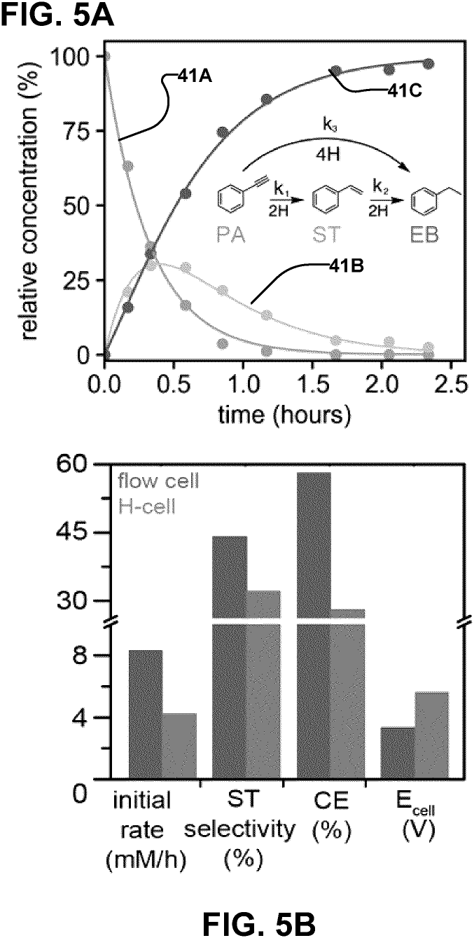

FIG. 5A is a graph that includes curve 41A showing concentration vs. time of PA, curve 41B showing concentration vs. time of ST and curve 41C showing concentration vs time of EB. The inset shows the phenylacetylene hydrogenation reaction mechanism in an ePMR.

FIG. 5B is a bar chart comparing reaction performance in an H-cell (like cell 30A) and a flow cell (like cell 30C) (with identical Pd surface area) using four reaction performance metrics: initial reaction rate; maximum styrene concentration; current efficiency (CE); and cell voltage (E_{cell}) at 100 mA/cm². The flow cell architecture enables higher performance in every metric than the H-cell.

The initial reaction rate increased 2-fold when the reaction was run in flow compared to the static H-cell environment, selectivity for styrene was also found to be slightly higher in the flow cell (i.e., 43% maximum styrene concentration versus 32% in the H-cell), and current efficiency was found to be 66% higher in the flow cell than the H-cell.

### Scale Up and Optimization

Electrocatalytic hydrogen permeable membrane reactors (comprising one or more cells as described herein) may be powered by renewable electricity to hydrogenate organic molecules at ambient temperatures and pressures. Flow cells as described herein which incorporate hydrogen permeable membranes as described herein can provide increased hydrogenation reaction rates compared to other technologies that do not rely on high temperatures and pressures. The hydrogen content in the hydrogen permeable (e.g. palladium) membrane can control the speed and selectivity of hydrogenation reactions, while the amount of H₂ gas evolved at first face 14 of a membrane 10 determines current efficiency.

The scalable flow cell architectures described herein can use electricity to drive hydrogenation chemistry without forming H₂ gas and may be applied in many applications including large scale industrial applications.

Flow cells (e.g. as illustrated by cell 30C may be designed to enable higher current densities, and therefore faster conversion rates. This may be done, for example by minimizing the interelectrode distance (i.e., the distance between a membrane 10 and an anode 36. Minimizing the interelectrode distance reduced voltage drops due to electrolyte resistance and enabled electrolysis at substantially higher current densities for similar applied voltages. Additional measures such as increasing anode surface area and/or implementing a zero-gap membrane electrode assembly design similar to flow cells used in other applications may facilitate operating cells as described herein at reduced voltages and/or higher current densities.

Contacting reactants with a membrane as described herein using a flow field at the side of the membrane where reactions such as hydrogenation occur helps to increase the rate of hydrogenation. Without being bound by any theory of operation it is thought that diffusion of reactants to first face 14 of a membrane 10 and/or the time for the hydrogenation reaction to complete is the rate-determining process. There are four steps that must proceed for hydrogenation to occur in a cell 30C. These are: proton reduction at second face 14′ of membrane 10; hydrogen permeation through dense layer 12 of membrane 10; diffusion of a reactant (e.g. an unsaturated organic molecule) to first face 14 of membrane 10; and hydrogen addition across an unsaturation of the reactant. Increasing the surface area first face 14 of membrane 10 available to reactants may also improve reaction rate.

The inventors have determined that:
i) catalyzed hydrogenation in cells as described herein may proceed via a sequential hydrogenation mechanism and also through a direct hydrogenation pathway (for example an alkyne may be directly converted to an alkane adduct in a single step).
ii) hydrogen content is deterministic of hydrogenation rate, with more absorbed hydrogen leading to faster, albeit less selective conversion.
iii) occurrence of the hydrogen evolution reaction at a surface of a membrane 10 corresponds to lower current efficiency and is therefore a parasitic process. These findings provide reactor and palladium membrane design principles for driving ePMR technologies toward applications in synthesis and commodity chemical manufacturing.

The presence of a direct hydrogenation pathway in at least some reactions may be identified using a quantitative kinetic model of hydrogenation at first face 14 of a membrane 10. A custom Python script was used to extract effective rate constants (i.e., the rate constant multiplied by [H]; denoted as kₓ′) for each step of the hydrogenation reaction by fitting a system of differential equations to reaction concentration profiles. Hydrogenation occurs through three reaction steps; the sequential hydrogenation of PA to ST then ST to EB are denoted by k₁ and k₂, respectively, and follow the well-established Horiuti-Polanyi mechanism. Including an additional hydrogenation pathway (k₃) to describe the direct conversion of PA to EB in a single step (FIG. 5A) resulted in the model producing a higher goodness-of-fit at every current density tested. This result provides evidence that alkynes can be converted to the fully hydrogenated adduct in a single step. Analyzing how k₃′ changes with current density explains the marked decrease in reaction selectivity at high current densities. The effective rate constant for the direct hydrogenation pathway (k₃′) is nearly 100-fold larger at 400 mA/cm² than at 10 mA/cm². High current densities result in lower selectivity for the ST intermediate because the sequential reaction pathway (that proceeds through the alkene intermediate) is circumvented under these conditions.

These findings indicate that partially saturated products (e.g., alkenes) may be obtained by shorter reaction times at lower current densities. Conversely, fully saturated products (e.g. alkanes) may be obtained by longer reaction times at higher current densities.

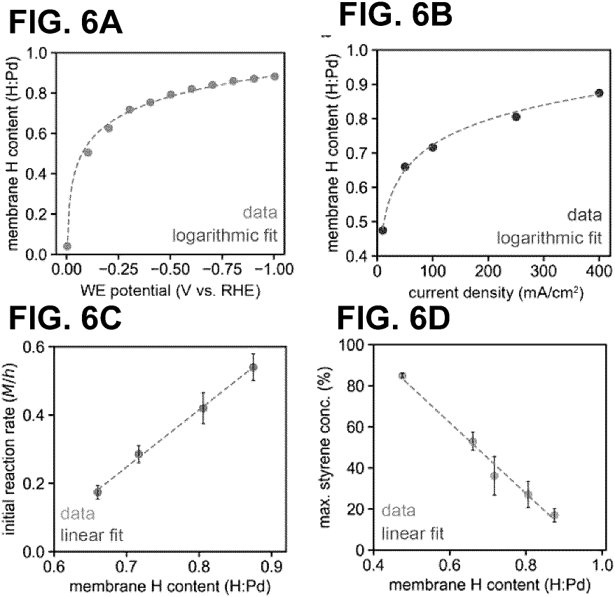

Reaction performance correlates to: i) the hydrogen content of the palladium membrane; and ii) the amount of hydrogen that evolves from the membrane surface. A coulometry method was used to conduct ex situ measurements of the palladium membrane hydrogen content (expressed as a ratio of H:Pd) at a range of potentials between 0 and -1.0 V vs RHE. FIG. 6A shows a logarithmic function fit to these data (R² = 0.99). The palladium membrane hydrogen content was calculated for each current density by substituting the average cathode potentials at 10, 50, 100, 250, and 400 mA/cm² into Equation 1:

$$y = 0.185 l n \left|x\right| + 0.907$$

Note that the rate data corresponding to the reaction performed at 10 mA/cm² was excluded because this reaction proceeded in a different kinetic regime than the reactions carried out at 50-400 mA/cm² (i.e., the reaction at 10 mA/cm² is zero-order in PA and ST, and reactions performed at 0-400 mA/cm² are first-order in PA and ST). Plotting the membrane hydrogen content against reaction rate and selectivity revealed a clear linear dependence of these performance metrics on the amount of hydrogen absorbed into the catalyst, with a higher concentration of hydrogen leading to faster, albeit less selective, hydrogenation (See FIGS. 6C and 6D).

The clear linear relationship between reaction rate and selectivity and the H:Pd ratio suggests that the amount of hydrogen absorbed into the palladium can be deterministic of reaction performance in an ePMR. This finding is qualitatively consistent with previous studies which show that catalytic promoters dissolved in the palladium catalyst (e.g., carbon, silver) decrease hydrogen loading, and resultantly increase the selectivity for the alkene intermediate (though at the cost of decreased reaction rate). Unique to the ePMR system, however, is that reaction rate and selectivity can be modulated by adjusting the current density, thus circumventing the need for exotic catalyst designs.

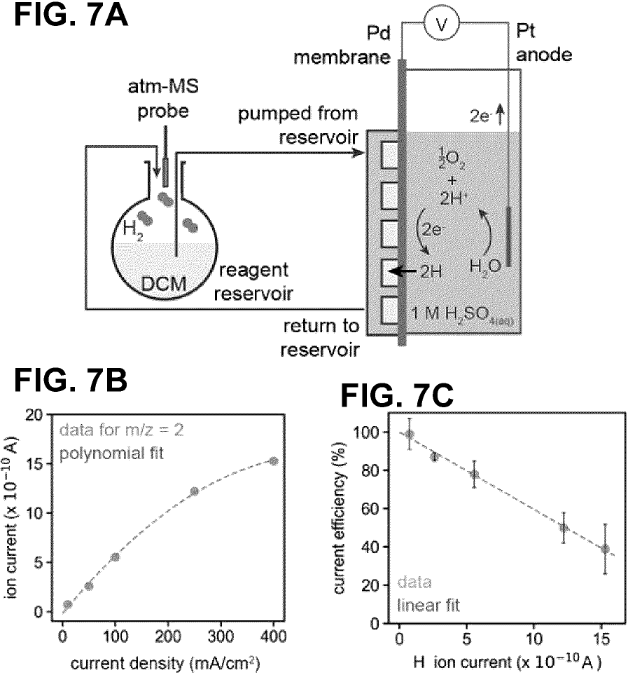

In situ mass spectrometry was used to study the influence of current density on current efficiency by measuring the amount of hydrogen evolved from the surface of a membrane 10 at various current densities. An atmospheric-mass spectrometer (atm-MS) was connected to the organic reagent reservoir filled with only 25 mL of DCM (FIG. 7A).

In these experiments, electrolysis was conducted for at least 1000 s at a current density of 10, 50, 100, 250, then 400 mA/cm² while DCM was continuously recirculated through the hydrogenation flow field. The amount of hydrogen that permeated through membrane 10 was measured by monitoring the mass to charge ratio for hydrogen (m/z = 2) with the atm-MS. Hydrogen permeation rate (which is proportional to the measured ion current) measured at each side of membrane 10 tracked exponentially with current density (FIG. 7B).

Current efficiency was found to scale linearly with permeated hydrogen, showing that hydrogen evolved from the membrane surface correlates to decreased current efficiency (FIG. 7C). It may be that hydrogen gas evolved from the surface of membrane 10 by the hydrogen evolution reaction is not involved in the hydrogenation reaction, and is indeed a parasitic side reaction. Hydrogen evolution rates may be reduced by modifying composition or surface energy of first face 14 of membrane 10.

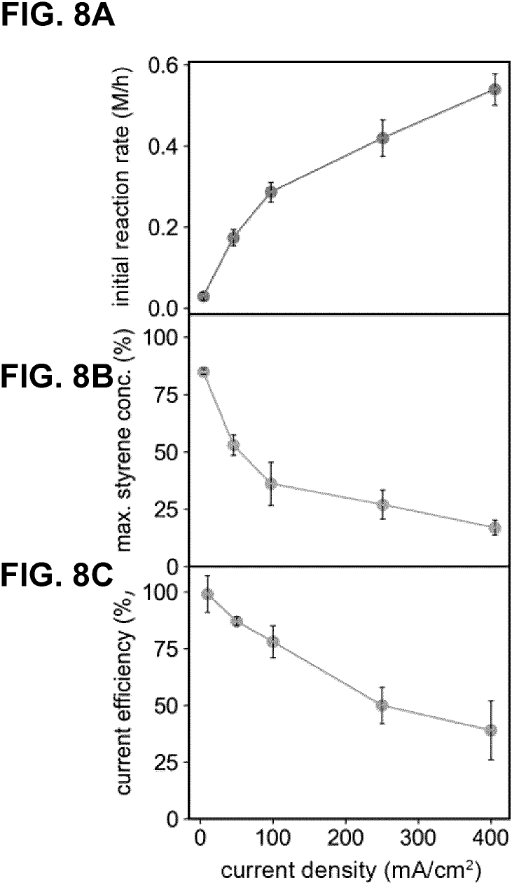

In some embodiments, electrolysis current density is controlled to select the reaction rate, selectivity, and current efficiency of a reaction. This was demonstrated in hydrogenation of PA in a flow cell 30C, using the entire 4 cm² surface area of membrane 10 and driving galvanostatic electrolysis at 10, 50, 100, 250, and 400 mA/cm². Reaction rate, selectivity and current efficiency were quantified for each reaction (FIGS. 8A to 8C). Higher current densities drive faster reaction rates (FIG. 8A) though at the cost of both the selectivity for the styrene intermediate (FIG. 8B) and current efficiency of the reaction (FIG. 8C), which decrease with increasing electrolysis current. These experiments show the marked effect that current density can have on reaction performance.

### Experiments and Example Chemical Reactions

The membranes and cells as described herein may be applied to perform a large range of chemical reactions. The following examples illustrate some examples of these reactions. Some example classes of chemical reactions are shown in Table A.

Table A. Overview of preferred palladium, co-catalyst, and solvent combinations for specific chemical reactions. For clarity, “hydrogenation” means reactions comprising any isotope of the element with the atomic number 1.

| | | | |
|---|---|---|---|
| Chemical Reaction | Membrane Material | Co-Catalyst | Solvent |
| Hydrodeoxygenation e.g. | Pd-membrane | Pt > Pd > Ni | Polar solvents, e.g. alcohols |
| Hydrogenation of alkenes e.g. | Pd-membrane | Pd > Ir > Pt >Au | Non-polar solvents |
| Hydrogenation of aldehydes e.g. | Pd-membrane | Pt > Au > Ir > Pd optionally pretreated with ethylenediamine | Polar, protic solvents, e.g. alcohols |
| Hydrogenation of ketones e.g. | Pd-membrane | Pt > Au > Ir > Pd | Polar, protic solvents |
| Hydrogenation of imines e.g. 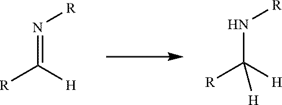 | Pd-membrane | Pt > Au > Ir > Pd | Polar, protic solvents, non polar solvents, alcohols |
| Dehydrogenation of alkanes e.g. 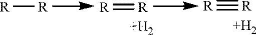 | Pd-membrane | Pd < Pt < Ir < Au | Neat or non-polar solvent. |

hydrogenation of acetophenone and styrene. Acetophenone hydrogenations were performed using either toluene or ethanol as the solvent. Styrene hydrogenation was performed using only toluene as the solvent. All reactions were carried out in air at room temperature. An oven-dried chemical compartment with a magnetic stir bar was filled with substrate (3 mmol) and solvent (30 mL). 1 M H₂SO₄ electrolyte solution (35 mL) was added to the electrochemical compartments and a constant current of 200 mA was applied for 8 h. Both reaction mixture and electrolyte solution were stirred at a constant rate throughout the experiment. Reaction aliquots were sampled every 2 h to monitor the reaction profile of acetophenone by ¹H NMR spectroscopy or every 0.5 h to monitor the reaction profile of styrene by GC-MS.

¹H NMR spectra were acquired on a Bruker Avance™ 400dir, 400inv, or 400sp spectrometer at ambient temperature operating at 400 MHz for ¹H nuclei. Chemical shifts (δ) are reported in parts per million (ppm). The spectra were calibrated using residual protio solvent peaks (¹H NMR, δ 7.26 for CDCl₃, 3.31 for methanol-d₄, 5.32 for CD₂Cl₂)

GC-MS experiments were performed on an Agilent GC-MS using an HP-5ms column and electron ionization MS detector.

The following Table B shows initial hydrogenation rates (mmol h⁻¹) of acetophenone and styrene for different catalysts. The initial rate of acetophenone conversion for each metal catalyst was determined by the slope of the first 2 h of acetophenone consumption (mmol h⁻¹) and the first 0.5 h of styrene consumption (mmol h⁻¹).

| Table B | | | | |
|---|---|---|---|---|
| | Pt/Pd | Au/Pd | Ir/Pd | Pd-black |
| Acetophenone in toluene | 0.17 | 0.13 | 0.043 | 0.0053 |
| Acetophenone in ethanol | 0.21 | 0.19 | 0.074 | 0.038 |
| Styrene in toluene | 0.60 | 0.56 | 0.65 | 0.70 |

Gas-phase hydrogenation of acetophenone. Gas-phase acetophenone hydrogenation was performed using toluene with 1 atm H₂. An oven dried chemical compartment with a magnetic stir bar was filled with toluene (30 mL) and the electrochemical compartment was kept empty. The chemical compartment was sealed with a rubber septum and a venting needle and toluene was purged with H₂ gas for 30 min. Acetophenone (3 mmol) was added to the chemical compartment using a syringe. A constant flow of H₂ gas was kept for 2 h then the venting needle was replaced with a 1 L H₂ balloon.

Hydrogen permeation. This experiment was conducted with 1 M sulfuric acid (H₂SO₄) in the electrochemical compartment and toluene or ethanol (EtOH) in the chemical compartment. The co-catalyst face 14 of membrane 10 was placed between the two compartments, facing into the chemical compartment. The production of gaseous H₂ (2 m/z) in the chemical and electrochemical compartment with constant stirring were monitored by atmospheric mass spectrometry (atm-MS) with a constant gas flow rate of 10 mL/min entering the instrument. An ESS CatalySys™ atmospheric mass spectrometer was used to for deuterium permeation experiments. Detection was switched between the chemical and electrochemical compartment every 5 s with a 3 s instrument purge between measurements. Permeation experiments were repeated using different foils 3-5 times. The ion current once the m/z signal had equilibrated equilibrated was used to determine the ratio of chemical:electrochemical H₂ evolution, which was averaged over 3-5 repeated runs using different foils.

Temperature Programmed Desorption (TPD). A quadrupolar mass spectrometer (ESS CatalySys) was used as the detector (the same instrument used for H permeation measurements). The inlet to the mass spectrometer was connected to the specially-designed TPD sample chamber and TPD spectrum were measured while passing a constant Ar flow (15 mL min⁻¹). The experiment was carried out at atmospheric pressure and a linear temperature ramp of 10 K min⁻¹ was used to measure TPD spectra. Mass analysis was performed every 50 ms for the following mass/charge fragments: 2 (H₂), 32 (O₂), 18 (H₂O), and 44 (CO₂). The samples were loaded with hydrogen by chronoamperometry in 0.1 M HCl at -0.4 V (vs Ag/AgCl) until total charge of 10 C was passed. The samples were quickly transferred to the liquid N₂ for 30 seconds before being transferred to the TPD chamber to commence the TPD experiment. The TPD chamber was kept in dry ice before the sample was transferred. The TPD chamber with the sample was then transferred to the heating system to perform the TPD experiment.

### Catalytic Hydrogenation of C=O and C=C

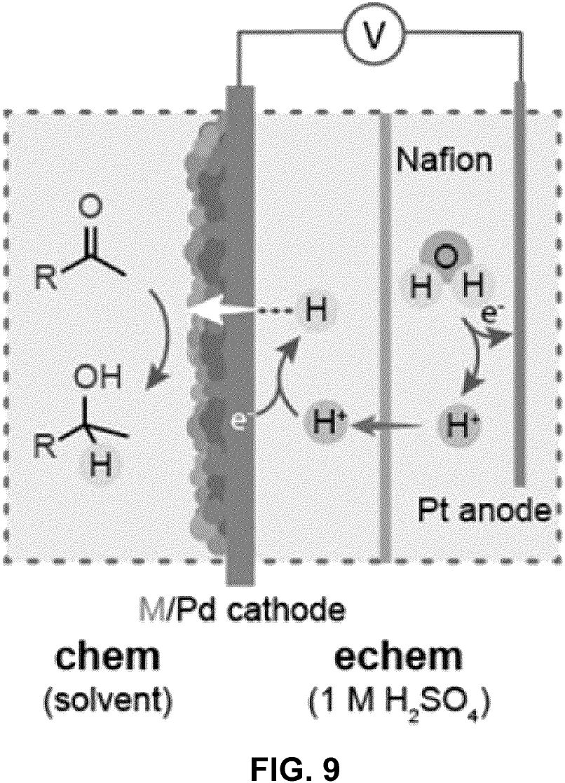

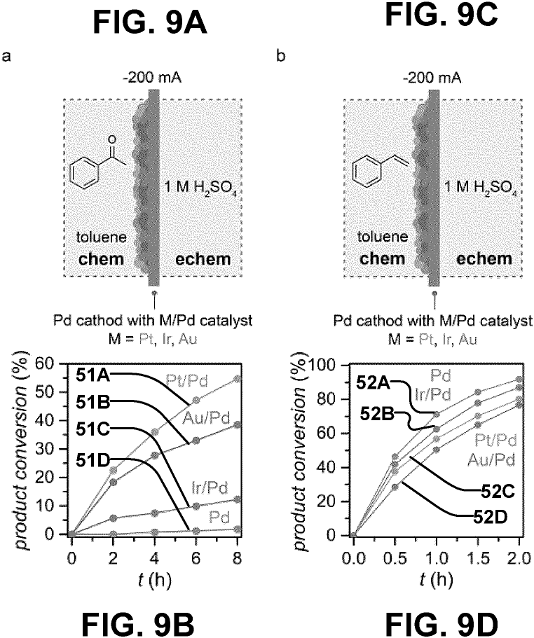

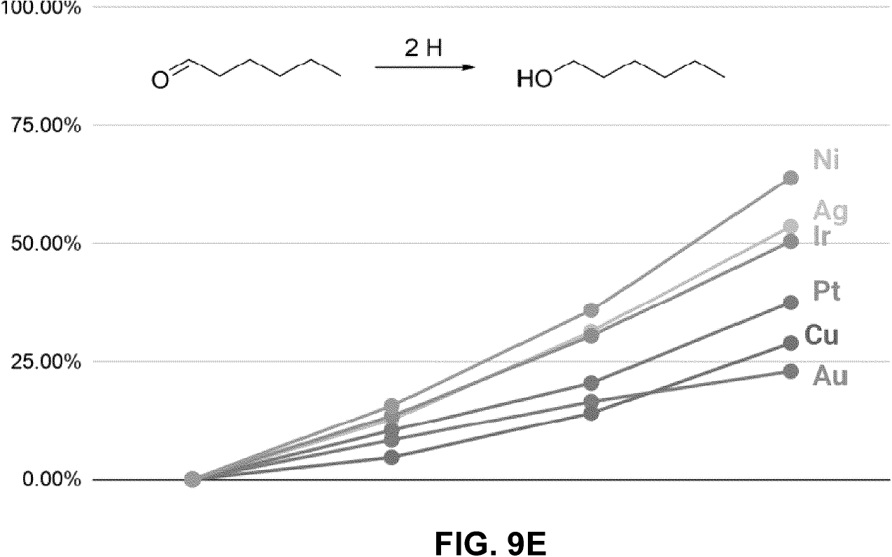

The reactivity of different co-catalysts for C=O hydrogenation were assessed by hydrogenating acetophenone as a model reactant. The M/Pd-membranes (M = Au, Ir, Pt) were tested in a three-compartment cell like cell 30C. Water oxidation occurred in an electrochemical compartment containing a platinum mesh anode. In a second electrochemical compartment facing a membrane 10 (palladium cathode) protons were reduced and absorbed by membrane 10. In a chemical compartment where the diffused hydrogen react with acetophenone. This is schematically illustrated in FIG. 9.

Two electrochemical compartments that contain 35 mL of 1 M H₂SO₄ electrolyte were separated by a Nation™ membrane. The voltage at the Pd-membrane cathode (working electrode) was measured against the Ag/AgCl reference electrode which was placed in the middle electrochemical compartment. The M/Pd-membranes separate the electrochemical and chemical compartments and was configured as the M/Pd side faced the chemical compartment that enables the hydrogenation on the surface of co-catalysts.

For each hydrogenation reaction, 0.1 M acetophenone solution in toluene (30 mL) was added to the chemical compartment and a constant current at 200 mA was applied to drive a water electrolysis and subsequent acetophenone hydrogenation.

Experiments were conducted to compare the activity of each catalyst design for the hydrogenation of C=O bonds using acetophenone as a model compound. A hydrogenation experiment using toluene as a reactant was performed with each catalyst design at identical current density. The initial rate of acetophenone conversion was measured for each metal catalyst (mmol h⁻¹).

These reactions are schematically shown in FIG. 9A. The results (see FIG. 9B) showed the incorporation of co-catalysts yielded faster acetophenone hydrogenation rates than that could be achieved with Pd-black for all co-catalysts. The initial reaction rates with co-catalysts were found to be 1-2 orders magnitude larger than that of Pd-black, wherein Pt/Pd catalyst (curve 51A) achieved the fastest rates (0.17 mmol h⁻¹) which then decreased in order of Au/Pd (curve 51B) (0.14 mmol h⁻¹) > Ir/Pd (curve 51C) (0.04 mmol h⁻¹) > Pd-black (curve 51D) (0.005 mmol h⁻¹).

FIG. 9E shows curves indicating the rate of hydrogenation of hexanal using a range of co-catalysts including Au, Cu, Pt, Ir, Ag, Ni.

The reactivity of co-catalysts for the hydrogenation of C=C bonds was also investigated. These hydrogenation experiments were performed at 200 mA using a styrene as a reactant (0.1 M in toluene). Styrene was selected for the similarity of this molecule to acetophenone (i.e., both molecules consist of a functional group conjugated to an aromatic backbone).These reactions are schematically shown in FIG. 9C. It was found that co-catalyst can be selected to optimize hydrogenation performance for different reactants (e.g. different types of unsaturated bonds).

Results of these experiments are shown in FIG. 9D. These experiments showed that Pd-black (curve 52A) yielded faster hydrogenation of C=C bonds than that achieved by the co-catalysts, showing 5-20% decreases in initial hydrogenation rates. Hydrogenation rates for Ir/Pd, Pt/Pd and Au/Pd are shown by curves 52B, 52C and 52D respectively. These results showed an opposite trend that was observed for the hydrogenation of C=O bonds and therefore demonstrate that the co-catalyst plays a significant role in hydrogenation rate.

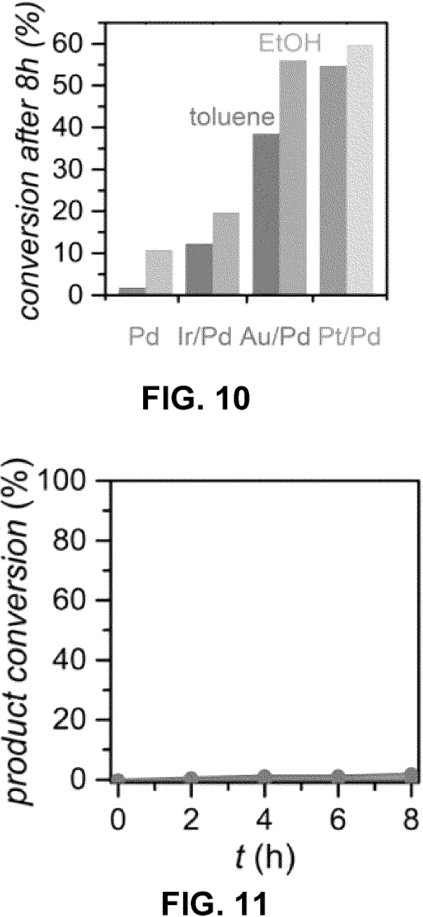

Another series of acetophenone hydrogenation experiments were conducted using ethanol as the solvent to investigate the effect of solvent choice on hydrogenation activity. The initial reaction rates for all catalysts increased by up to a factor of 10 compared to that in toluene (See FIG. 10 - in each pair of bars the longer bar on the right is for ethanol and the shorter bar on the left is for toluene). This shows that higher reactivity can be achieved when using a polar, protic solvent. We note that the same trend of reactivity of co-catalysts was retained (Pt/Pd > Au/Pd > Ir/Pd > Pd-black despite the overall increase in the initial rates.

A control experiment was conducted to assess whether delivery of activated hydrogen through the membrane results in more efficient hydrogenation than could be achieved by simply delivering H₂ gas to first surface 14 of the membrane where hydrogenation occurs. In the control experiment the chemical compartment containing 0.1 M acetophenone solution in toluene was placed under 1 atm pressure of H₂ gas without applying any electrochemical bias. The acetophenone conversion was found to be negligible (< 2% for all catalysts) after 8h (See FIG. 11).

### Mechanistic Study of Hydrogen Desorption Kinetic Changes Due to Co-Catalyst On Palladium Membrane

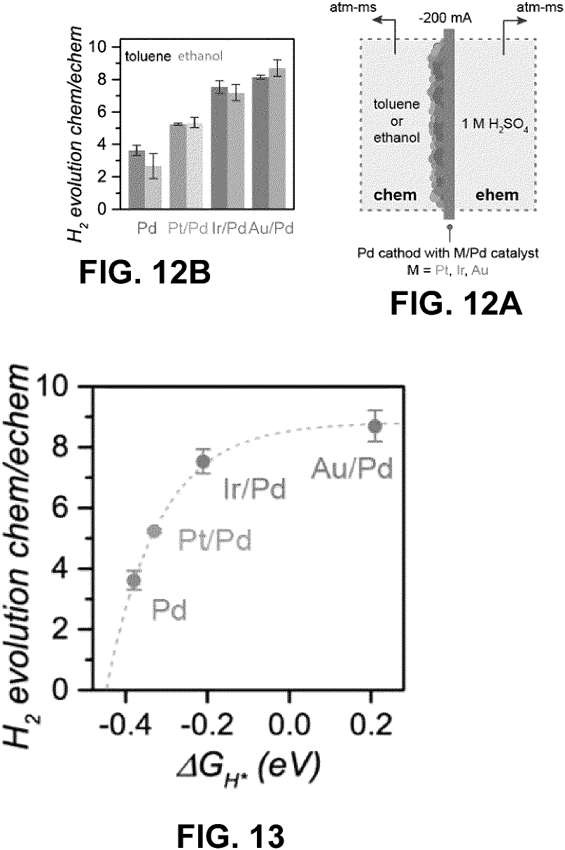

Experiments to assess the influence of co-catalysts incorporation on the amount of hydrogen that permeates through the membrane (the hydrogen flux) were performed by monitoring the relative production of gaseous H₂ (mass-to-charge ratio of 2 m/z) in the chemical compartment to that in the electrochemical compartment with atmospheric-mass spectrometer (atm-MS). The experimental setup is schematically shown in FIG. 12A. The chemical compartment was filled with toluene or ethanol in the absence of a reactant and the electrochemical compartment was filled with 1 M H₂SO₄ with applied current at 200 mA. The results show that more hydrogen gas evolved in the chemical compartment throughout a series of catalysts; however, Pd-black catalyst yielded the lowest hydrogen flux.

FIG. 12B shows results of these experiments. Incorporation of a co-catalyst increased the flux of hydrogen through the membrane in an order of Pd < Pt/Pd < Ir/Pd < Au/Pd. The relative amount of H₂ generation measured in ethanol and toluene showed no difference, which highlighted increasing solvent polarity had negligible effect on the hydrogen flux. Solvent polarity had negligible effect (changes within error bars) on the hydrogen flux. The relative amount of H₂ formation was then plotted as a function of calculated hydrogen adsorption energy (ΔGH*) for the pure metal surface (N⌀rskov et al. 2005). The plot of FIG. 13 shows that the hydrogen flux was exponentially proportional to the hydrogen adsorption energies on each co-catalyst metal.

To understand the origin of the increased hydrogen flux by incorporation of the catalyst, desorption kinetics of surface-adsorbed (H_{ads}) and absorbed hydrogens (H_{abs}) were investigated by ex-situ electrosorption of hydrogen and temperature-programmed desorption (TPD) method.

TPD samples were prepared by submerging Pd or M/Pd foils (~1 × 0.5 cm) in 0.1 M HCl with a -0.4 V (vs. Ag/AgCl) until a total charge of 10 C was passed to saturate the sample with H_{abs}. The samples were then cooled at 77 K in liquid nitrogen for 30 s to suppress immediate desorption of H_{ads} and H_{abs} before being transferred to a TPD chamber.

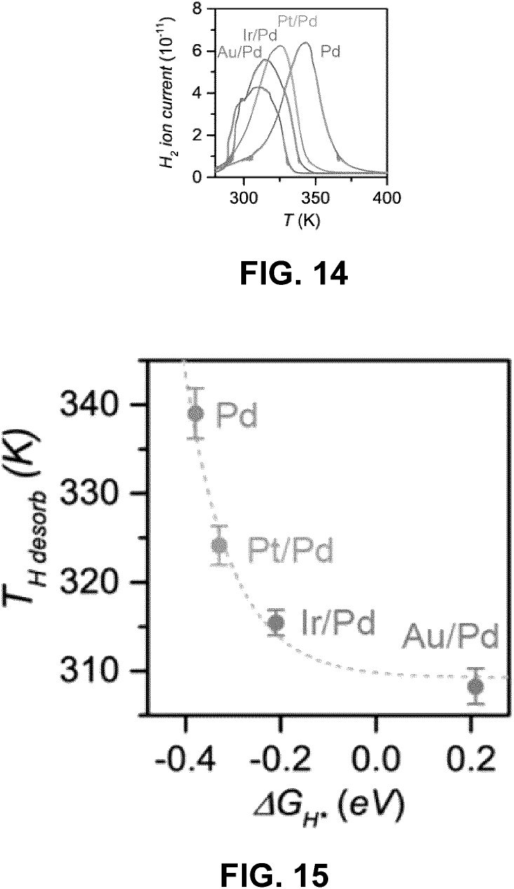

Hydrogen desorption was monitored by tracking the mass-to-charge ratio for hydrogen (m/z = 2) with an atmospheric-mass spectrometer. FIG. 14 shows TPD spectra for different co-catalysts. Hydrogen desorption temperature was determined by the peak maximum of the desorption event with linear temperature ramp of 10 K min-1.

Incorporation of co-catalysts 16 on a Pd-black surface (e.g. first face 14 of a membrane 10) resulted in a decrease in hydrogen desorption temperature (T_{Hdesorb}) compared to Pd-black without co-catalysts. Hydrogen desorbed at the lowest temperature on the surface of Au/Pd (308 K) and the desorption temperature increased as Ir/Pd (315 K) < Pt/Pd (324 K) < Pd (340 K) (See FIG. 14).

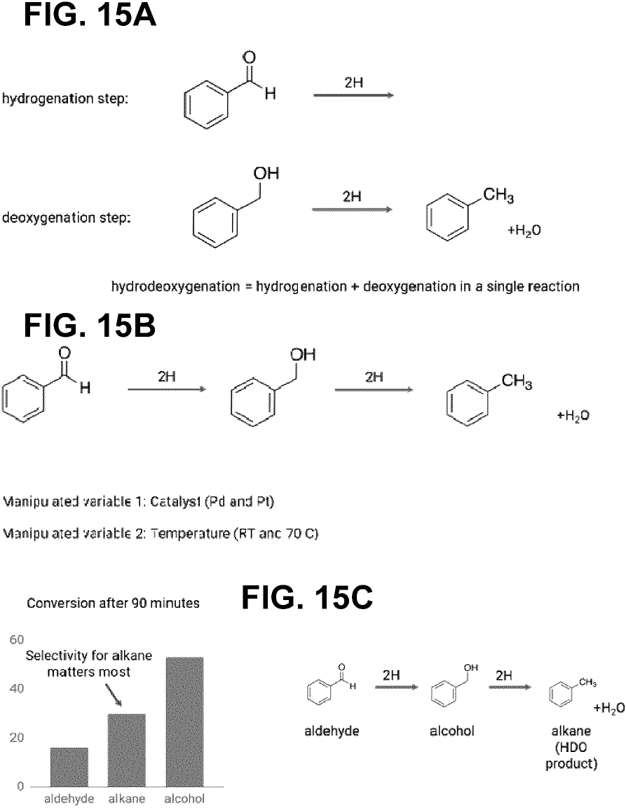

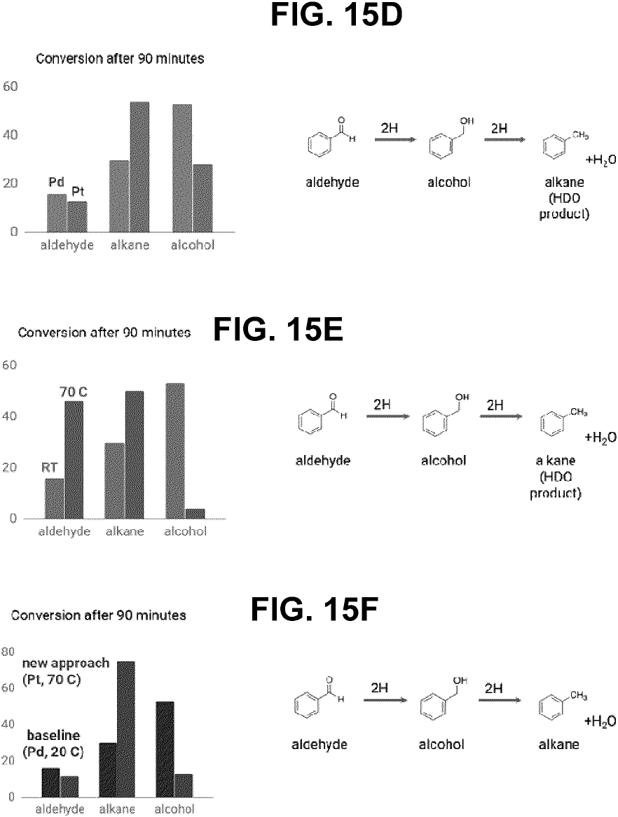

The hydrogen desorption temperatures were then plotted as a function of calculated hydrogen adsorption energy (ΔG_{H}*) for the pure metal surface (see FIG. 15). The results showed exponential dependence of the hydrogen desorption temperature on the hydrogen adsorption energies on each metal surface, wherein the metal catalysts with more positive hydrogen adsorption energy (i.e. weaker metal-hydrogen (M-H) binding energy, Au) led to hydrogens desorbing at lower temperature whereas ones with more negative adsorption energy (i.e., stronger M—H binding energy, Pd) resulted in high hydrogen adsorption energy. The dotted line in FIG. 15 is an exponential decay fit of the experimental data.

The TPD and permeation experiment results suggest that co-catalysts with weaker M-H binding energy (Au, Ir, Pt) may lead to faster hydrogen desorption and hence larger hydrogen flux through the Pd-membrane compared to Pd-black. This increase in hydrogen flux may enhance reactivity of co-catalysts.

### Catalytic Dehydrogenation Using the M/Pd Membrane

Dehydrogenation reactions are relevant to hydrogen storage applications. A hydrogen permeable membrane as described herein may be applied to promote dehydrogenation reactions which follow the general procedure for hydrogenation described above, and produce hydrogen gas as a byproduct. It is known that the reactivity for dehydrogenation increases, when a catalyst with low metal-hydrogen binding energy is used (Hunger et al., 2016); therefore, an increase in the dehydrogenation reactivity may be anticipated for co-catalysts in the order of Pd < Pt < Ir < Au.

### Catalytic Hydrodeoxygenation Using the M/Pd Membrane

Hydrodeoxygenation is a process that adds hydrogen atoms to and removes oxygen atoms from a molecule. Hydrodeoxygenation may be applied to transform biologically-derived feedstocks (e.g., vegetable oil, pyrolyzed agricultural waste, or animal tallow) into useful hydrocarbon fuels and commodity chemicals (such as e.g. renewable diesel). FIG. 15A shows that hydrodeoxygenation can be viewed as a two-step hydrogenation reaction followed by a deoxygenation reaction. FIG. 15B shows an example hydrodeoxygenation reaction.

To perform a hydrodeoxygenation reaction a flow cell like cell 30C of FIG. 4D assembled with first face 14 of a membrane 10 facing flow field 31B. Benzadehyde (0.26 g, 2.5 mmol) and DCM (25 mL) were added to the reagent reservoir and stirred at a consistent rate. Reaction aliquots were sampled every 1-30 minutes, depending on the current density and the duration of the reaction (e.g., 400 mA/cm² reactions were sampled approximately every 1 minute for the first 5 samples, then every 10 minutes for the remaining samples, and 10 mA/cm² reactions were sampled approximately every 30 minutes from start to finish), such that 10-15 samples were collected for each reaction. Reactions were monitored by gas chromatography-mass spectrometry (GC-MS) by diluting 20 µL of the reaction mixture in 1 mL of DCM. Toluene (the hydrodexoygenated product), and benzyl alcohol were observed as products.

FIGS. 15C to 15F show results of these measurements of the hydrodeoxygenation of benzaldehyde using different co-catalysts at different temperatures. The highest selectivity for the desired product was achieved using a Pt co-catalyst in the palladium membrane and increasing the reaction temperature from ambient to 70° C. (FIG. 15F).

Although various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way. Numeric ranges are inclusive of the numbers defining the range. The word “comprising” is used herein as an open-ended term, substantially equivalent to the phrase “including, but not limited to”, and the word “comprises” has a corresponding meaning. As used herein, the singular forms “a”, “an” and “the” include plural referents unless the context clearly dictates otherwise. Thus, for example, reference to “a thing” includes more than one such thing. Citation of references herein is not an admission that such references are prior art to an embodiment of the present invention. The invention includes all embodiments and variations substantially as hereinbefore described and with reference to the examples and drawings. Titles, headings, or the like are provided to enhance the reader’s comprehension of this document, and should not be read as limiting the scope of the present invention.

### REFERENCES

The entire disclosures of all applications, patents, and publications, cited above and below, are hereby incorporated by reference.
Berlinguette, C; Sherbo, R: Methods and apparatus for performing chemical and electrochemical reactions, WO 2019/144,239.
Delima, RS et al.: Supported palladium membrane reactor architecture for electrocatalytic hydrogenation. J Mat Chem A: Mat Energy Sustain 2019 (7) 26586.
Hunger, M et al.: Relationship between the hydrogenation and dehydrogenation properties of Rh-, Ir-, Pd-, and Pt-containing zeolites Y studied by in situ MAS NMR spectroscopy and conventional heterogenous catalysis. J Phys Chem C 2016 (120) 2284.
Iwakura, C et al.: Construction of a new dehydrogenation system using a two-compartment cell separated by a palladized Pd sheet electrode. J Electroanal Chem 1999 (463) 116.
Iwakura, C et al.: New hydrogenation systems of unsaturated organic compounds using noble metal-deposited palladium sheet electrodes with three-dimensional structures. J Mater Res 1998 (13) 821.
Kyriakou, G et al.: Isolated metal atom geometries as a strategy for selective heterogeneous hydrogenations. Science 2012 (335) 1209.
N⌀srskov, JK et al.: Trends in exchange current for hydrogen evolution. J Electrochem Soc 2005 (152) J23.
Salvatore, DA et al.: Electrolysis of gaseous CO₂ to CO in a flow cell with a bipolar membrane. ACS Energy Lett 2018 (3) 149.
Sherbo, RS et al.: Efficient electrocatalytic hydrogenation with a palladium membrane reactor. J Am Chem Soc2019 (141,19) 7815.
Sherbo, RS et al.: Complete electron economy by pairing electrolysis with hydrogenation. Nature Cat 2018 (1) 502.
Weekes, DM et al.: Electrolytic CO2 reduction in a flow cell. Acc Chem Res 2018 (51) 910.

### INTERPRETATION OF TERMS

Unless the context clearly requires otherwise, throughout the description and the claims:
“about” with reference to a value means ±10%.
“hydrogen” refers to any isotope of the element with the atomic number 1 (including deuterium).
“palladium” includes palladium metal, alloys that include palladium and other combinations of palladium metal with other materials. For example, a “palladium membrane” may be formed by electrodepositing one or more layers of palladium onto a substrate (which may, for example, comprise a palladium foil, or a porous polymer).
“M/Pd membrane” means a palladium (Pd) membrane comprising at least one metallic co-catalyst (M). The metallic co-catalyst may, for example, comprise one or more transition metals, such as gold, iridium, nickel, palladium, or platinum.
“H-cell” means a two-compartment reactor architecture. For illustration purposes only, and not to limit the scope of the invention, FIG. 4B shows an example of an H-cell.
“ePMR” refers to an “electrocatalytic palladium membrane reactor” that includes an electrochemical compartment and hydrogenation compartment separated by a palladium membrane that includes a transition metal catalyst.
“ePMR flow cell” is an abbreviation for “electrocatalytic palladium membrane reactor flow cell”. For illustration purposes only, and not to limit the scope of the invention, FIGS. 4C and 4D illustrate an example of an ePMR flow cell.
“geometric area” of a face such as a face of a membrane means an area of the face not including surface roughness. For example, a face of a membrane having a length of 1 cm and a width of 1 cm has a geometric area of 1 cm². If the face has a rough surface the actual surface area of the face may be significantly larger than the geometric surface area.
“comprise”, “comprising”, and the like are to be construed in an inclusive sense, as opposed to an exclusive or exhaustive sense; that is to say, in the sense of “including, but not limited to”.
“connected”, “coupled”, or any variant thereof, means any connection or coupling, either direct or indirect, between two or more elements; the coupling or connection between the elements can be physical, logical, or a combination thereof.
“herein”, “above”, “below”, and words of similar import, when used to describe this specification, shall refer to this specification as a whole, and not to any particular portions of this specification.
“or”, in reference to a list of two or more items, covers all of the following interpretations of the word: any of the items in the list, all of the items in the list, and any combination of the items in the list.
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Any terms not explicitly defined herein have the meanings commonly associated with those words as understood within the field of art to which the present technology relates.

Methods as described herein may be made up of a number of steps, processes or blocks that are presented in a given order. Each of the steps processes or blocks may be implemented in a variety of different ways. Where processes or blocks are shown as being performed in series, these processes or blocks may instead be performed in parallel, or may be performed at different times. Alternative example methods may comprise steps, processes or blocks that are presented in a different order and/or are implemented in different ways while achieving a desired outcome (such as hydrogenation of a material). Such alternatives to the described embodiments may be created by deleting, moving, adding, subdividing, combining, and/or modifying some steps processes or blocks to provide alternative methods and/or methods that are subcombinations of the steps, processes or blocks of the described methods.

Where a component (e.g. a pump, conduit, power supply, assembly, device, , etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

The reference to any literature herein is not, and should not be taken as, an acknowledgement or any form of suggestion that that the reference forms part of the common general knowledge in any country.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections, sentences or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A hydrogen permeable membrane comprising:
a dense layer of a hydrogen permeable metal having first and second faces;
the first face of the dense layer having a rough surface; and
one or more co-catalysts on the rough surface, wherein:
the one or more co-catalysts have an area density not exceeding 20 µg per cm²; and/or
a majority of the co catalysts are in an outer portion of the rough surface, the outer portion of the rough surface being less than one half of a thickness of the rough surface defined by peaks of the rough surface;
the one or more co-catalysts are in the form of a discontinuous layer having a thickness of 50 nm or less on the rough surface.

2. The membrane according to claim 1 wherein at least 60% of the co-catalyst is concentrated in an outer ⅓ of the rough surface of the first face of the dense layer.

3. The membrane according to claim 1 wherein the one or more co-catalysts comprise one or more transition metals.

4. The membrane according to claim 1 wherein the one or more co-catalysts comprise a co-catalyst selected from the group consisting of: platinum (Pt), iridium (Ir), ruthenium (Ru), gold (Au), nickel (Ni), silver (Ag) and copper (Cu).

5-7. (canceled)

8. The membrane according to claim 1 wherein the one or more co-catalysts have a maximum thickness on the first face not exceeding 50 nm.

9. The membrane according to claim 8 wherein the one or more co-catalysts have a maximum thickness on the first face in the range of 15 nm to 25 nm.

10. The membrane according to claim 1 wherein the rough surface comprises a layer of palladium black deposited on the dense layer.

11. The membrane according to claim 1 wherein an actual area of the first face is at least 200 times larger than a geometric area of the first face.

12. The membrane according to claim 1 wherein the dense layer comprises palladium having a purity of at least 95%.

13. (canceled)

14. The membrane according to claim 1 wherein the dense layer comprises a hydrogen storage material, and wherein the dense layer comprises a deuterium selective material.

15. The membrane according to claim 1 wherein the dense layer comprises a foil having a thickness of 100 µm or less.

16. The membrane according to claim 1 wherein the dense layer has a thickness in the range of 15 µm to 40 µm.

17. The membrane according to claim 1 wherein the dense layer comprises a fluid permeable substrate and a layer of the hydrogen permeable metal on the substrate.

18. (canceled)

19. An electrochemical cell comprising:
a membrane according to claim 1 located between a chemical reaction chamber and an electrochemical reaction chamber; and
an anode in fluid contact with the electrochemical reaction chamber.

20. The electrochemical cell according to claim 19 wherein the chemical reaction chamber comprises a flow field in contact with the first face of the membrane.

21. The electrochemical cell according to claim 19 wherein the membrane is clamped between the flow field and a clamping plate and the clamping plate is formed with apertures which provide fluid communication between the second face of the membrane and the electrochemical reaction chamber.

22. The electrochemical cell according to claim 19 comprising an ion-permeable membrane in the electrochemical reaction chamber between the anode and the membrane, the ion permeable membrane dividing the electrochemical reaction chamber into a first part in contact with the membrane and a second part in contact with the anode.

23-24. (canceled)

25. The electrochemical cell according to claim 19 comprising an acid solution in the electrochemical chamber, wherein the acid solution comprises deuterium ions and a ratio of deuterium ions to hydrogen ions in the acid solution is at least 1:1.

26. (canceled)

27. The electrochemical cell according to claim 19 wherein the chemical reaction chamber comprises a serpentine flow field.

28. (canceled)

29. The electrochemical cell according to claim 19 comprising a power supply connected between the anode and the membrane with a polarity such that the membrane is electrically negative relative to the anode, wherein the power supply is configured to supply an electrical current to the membrane and to regulate the electrical current to have a value in the range of 10 to 400 mA per cm² of the geometric area of the first face of the membrane.

30-89. (canceled)
